(19) United States
(12) Patent Application Publication
(10) Pub. No.: US 2013/0111181 A1
(43) Pub. Date: May 2, 2013

(54) METHODS AND APPARATUS FOR INCREASING DEVICE ACCESS PERFORMANCE IN DATA PROCESSING SYSTEMS

(71) Applicants: Srinivasa Rao Kothamasu, Bangalore (IN); George Wayne Nation, Rochester, NY (US); Krishna Venkanna Bhandi, Bangalore (IN)

(72) Inventors: Srinivasa Rao Kothamasu, Bangalore (IN); George Wayne Nation, Rochester, NY (US); Krishna Venkanna Bhandi, Bangalore (IN)

(73) Assignee: LSI CORPORATION, Milpitas, CA (US)

(21) Appl. No.: 13/286,109

(22) Filed: Oct. 31, 2011

(51) Int. Cl. G06F 12/08

(52) U.S. Cl. 711/202; 711/E12.017

(57) ABSTRACT

A data processing system comprises a device and device access circuitry. The device is mapped to a first mapped address region and to a second mapped address region. The device access circuitry, in turn, is operative to access the device in accordance with a first set of memory attributes when addressing the device within the first mapped address region and to access the device in accordance with a second set of memory attributes when addressing the device within the second mapped address region. The first set of memory attributes is different from the second set of memory attributes.

### BACKGROUND

In data processing systems with memory-mapped input/output (I/O), the same address bus may be utilized to access both memory devices and I/O devices (e.g., peripherals). To do so, each such device is mapped into its own region of the address space and is enabled only when a data processor asserts an address within that device's mapped address region. Thus the same instructions utilized to access memory devices may also be utilized to access the memory resources within I/O devices. This generally simplifies the system design and leads to cheaper, faster, and simpler hardware, a particular advantage in embedded systems.

Each mapped address region in a memory-mapped data processing system is typically assigned a set of memory attributes that determine the behavior of accesses to the respective device associated with that mapped address region. Typical memory attributes may include “normal,” “device,” and “strongly ordered.” When addressing a device that is assigned a “normal” memory attribute, for example, the data processor may re-order access transactions for efficiency and may also perform speculative reads on that device. In contrast, when accessing a device that is assigned a “device” memory attribute (frequently an I/O device), the data processor may attempt to preserve the transaction order relative to other transactions that access “device” and “strongly ordered” devices. Finally, when addressing a device that is assigned a “strongly ordered” memory attribute, the data processor may attempt to preserve transaction order relative to all other transactions.

Additional memory attributes may include, for example, “shared” or “non-shared,” “cacheable” or “non-cacheable,” and “execute never.” A purpose of the “shared” memory attribute is to permit accesses on a single device by multiple processors. Such a memory attribute assures data synchronization between bus masters in a system with multiple bus masters. A device that is assigned a “cacheable” attribute (usually also having a “normal” memory attribute), moreover, may allow data from that device to be stored in a local cache memory for the purpose of speeding up subsequent accesses. Finally, a device that is assigned a “never execute” memory attribute may prevent the data processor from reading instructions from that device.

The assigning of mutually exclusive memory attributes (e.g., “normal” and “strongly ordered”) to a single mapped address region, as may be done using, for example, synonyms in virtual-to-physical address mapping, may result in unpredictable behavior.

### SUMMARY

Illustrative embodiments of the invention relate to apparatus and methods for use in assigning multiple sets of memory attributes to a single device in a data processing system. Mapping multiple sets of memory attributes to a single device allows a data processing system to vary the memory attributes of that device based on the type of transaction that is currently being utilized to access that device. Such flexibility, in turn, results in enhanced system performance.

In accordance with an embodiment of the invention, a data processing system comprises a device and device access circuitry. The device is mapped to a first mapped address region and to a second mapped address region. The device access circuitry, in turn, is operative to access the device in accordance with a first set of memory attributes when addressing the device within the first mapped address region and to access the device in accordance with a second set of memory attributes when addressing the device within the second mapped address region. The first set of memory attributes is different from the second set of memory attributes.

In accordance with another embodiment of the invention, a method for accessing a device in a data processing system comprises mapping the device to a first mapped address region and to a second mapped address region. Subsequently, device access circuitry is caused to access the device in accordance with a first set of memory attributes when addressing the device within the first mapped address region and to access the device in accordance with a second set of memory attributes when addressing the device within the second mapped address region. The first set of memory attributes is different from the second set of memory attributes.

In accordance with yet another embodiment of the invention, an integrated circuit comprises a device and device access circuitry. The device is mapped to a first mapped address region and to a second mapped address region. The device access circuitry, in turn, is operative to access the device in accordance with a first set of memory attributes when addressing the device within the first mapped address region and to access the device in accordance with a second set of memory attributes when addressing the device within the second mapped address region. The first set of memory attributes is different from the second set of memory attributes.

Embodiments of the present invention will become apparent from the following description of embodiments thereof, which are to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 shows a block diagram of a portion of a data processing system in accordance with an illustrative embodiment of the invention;

FIG. 2 shows a table listing memory attributes as a function of mapped address region for the FIG. 1 data processing system, in accordance with an illustrative embodiment of the invention;

FIG. 3 shows a table of the modeled number of accesses and system clock cycles required to transfer data from a slave device utilizing “normal” and “cacheable” memory attributes, in accordance with an illustrative embodiment of the invention;

FIG. 4 shows a table of the modeled number of accesses and system clock cycles required to transfer data from a slave device utilizing a “device” memory attribute, in accordance with an illustrative embodiment of the invention; and

FIG. 5 shows a block diagram of at least some of the elements within a system interconnect in the FIG. 1 data processing system, in accordance with an illustrative embodiment of the invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DESCRIPTION OF EMBODIMENTS

Embodiments of the invention will be described herein in the context of illustrative data processing systems operative to assign a single device to two or more sets of memory attributes. It should be understood, however, that the described embodiments are not to be considered as limiting to the described or any other particular circuit arrangements. Rather, embodiments of the invention are more generally applicable to any data processing systems that utilize memory attributes in association with device accesses. Moreover, it will become apparent to those skilled in the art given the teachings herein that numerous modifications can be made to the embodiments shown that are within the scope of the claimed invention. That is, no limitations with respect to the embodiments described herein are intended or should be inferred.

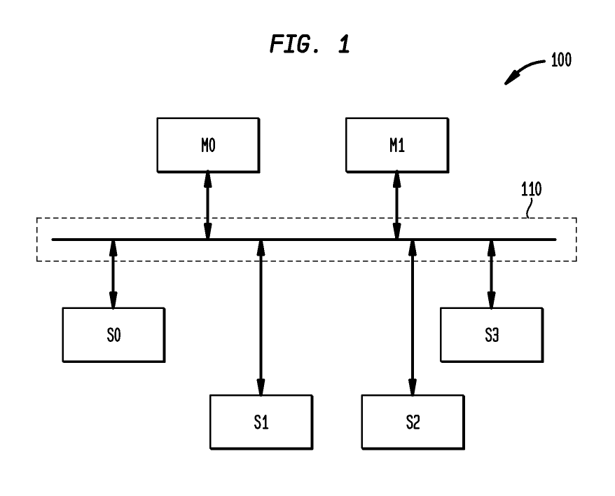

FIG. 1 shows a block diagram of at least a portion of a data processing system 100, in accordance with an illustrative embodiment of the invention. In the illustrative data processing system 100, two “master” devices, M0 and M1, as well as four “slave” devices, S0-S3, are interconnected by a system interconnect 110. The master devices M0, M1 may comprise, for example, data processors, while the slave devices S0-S3 may comprise various memory devices (e.g., read-only memory (ROM) devices and random access memory (RAM) devices) as well as various I/O devices (e.g., memory peripherals, video peripherals, sound peripherals, sensor peripherals, network peripherals, and data processing peripherals). In a non-limiting embodiment of the invention, the data processing system 100 may comprise, for example, a system-on-chip (SoC) such as that which might be found in an embedded system.

As is known in data processing systems with memory-mapped I/O, each slave device S0-S3 in the data processing system 100, whether it is a memory device or an I/O device, is mapped onto its own region of the data processing system's address space, and is enabled when one of the data processors M0, M1 asserts an address within that slave device's mapped address region on the system interconnect 110. Nevertheless, while the data processing system 100 utilizes memory-mapped I/O, such memory mapping is not performed in a conventional manner. Instead, in accordance with some embodiments of the invention, the data processing system 100 comprises a slave device (in this particular example, the slave device S2) that is mapped to a first mapped address region and to at least a second mapped address region. The data processors M0, M1 may, in turn, access the slave device S2 in accordance with a first set of memory attributes when addressing the device within the first mapped address region, and access the slave device S2 in accordance with a second, different set of memory attributes when addressing the slave device S2 within the second mapped address region. It is to be appreciated that the first and second sets of memory attributes may include one or more common elements, but that the first and second sets of memory attributes, when considered as a whole, are different compared to one another.

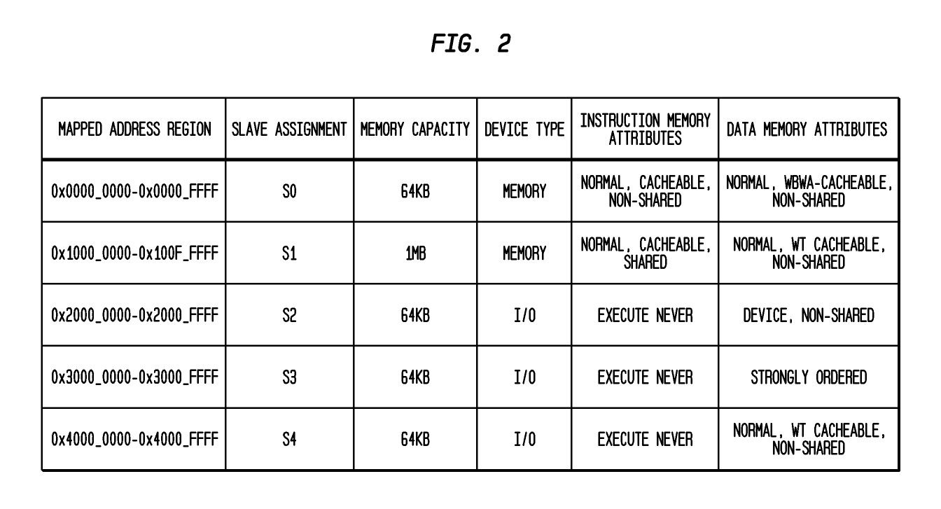

FIG. 2 may help to make this novel configuration more apparent. Specifically, FIG. 2 shows a table describing an illustrative system address map for the slave devices S0-S3 within the data processing system 100, in accordance with an embodiment of the invention. For each system address region (in a hexadecimal representation), slave assignment, memory capacity, device type (i.e., memory or I/O), instruction memory attributes, and data memory attributes are listed. The instruction memory attributes and data memory attributes collectively form the set of memory attributes for the given mapped address region. Sets of memory attributes like those shown in FIG. 2 are programmed into the data processors M0, M1 via their memory management units or memory protection units.

Instruction memory attributes and data memory attributes include, for example, “normal,” “cacheable,” “non-shared,” and “execute never,” each of which was described earlier. Of course it is to be understood that embodiments of the invention are not limited to the number and/or types of memory attributes. The data memory attributes also include “WT cacheable” and “WBWA cacheable” memory attributes. The “WT cacheable” memory attribute corresponds to a “write-through” cache wherein every write to the cache causes a synchronous write to the associated device. The “WBWA cacheable” memory attribute corresponds to a “write-back and write-allocate” cache, wherein data is only written to the associated device when the data is evicted from the cache. All the same, despite the specific memory attribute assignments shown in FIG. 2, those assignments are merely for illustrative purposes and are largely arbitrary. In actual application, a single device may be associated with more than two memory address regions and, alternatively or additionally, many devices, rather than just one, may be associated with multiple respective mapped address regions. Moreover, memory attributes and combinations of memory attributes different from those explicitly shown in the figure may be assigned to the devices. The memory attributes shown in FIG. 2, as well as others, will be familiar to one skilled in the art, and are also discussed in detail in several technical reference manuals for numerous types of processors.

As will be evident from the table in FIG. 2, the slave devices S0, S1, and S3 in the illustrative embodiment are mapped to unique mapped address regions while the slave device S2, as mentioned above, is mapped to two different mapped address regions with different respective sets of memory attributes. Such a configuration has the effect of allowing the master devices M0, M1 to address the slave device S2 in accordance with two different sets of memory attributes, depending on which mapped address region is utilized. If the master devices M0, M1, for example, access the slave device S2 within mapped address region 0x2000_{—}0000-0x2000_FFFF (hereinafter the “first mapped address region”), then the master devices M0, M1 will access the slave device S2 in accordance with the “execute never,” “device,” and “non-shareable” memory attributes (hereinafter the “first set of memory attributes”). Instead, if the master devices M0, M1 access the same slave device S2 within the mapped address region 0x4000_{—}0000-0x4000_FFFF (hereinafter the “second mapped address region”), then the master devices M0, M1 will access the slave device S2 in accordance with the “execute never,” “normal,” “WT cacheable,” and “non-shared” memory attributes (hereinafter the “second set of memory attributes”).

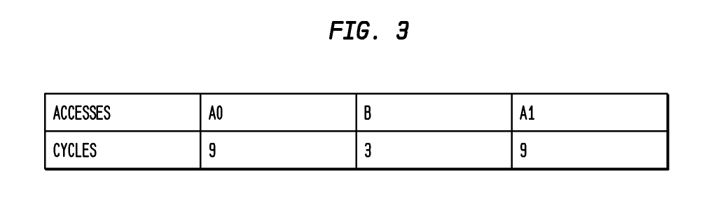

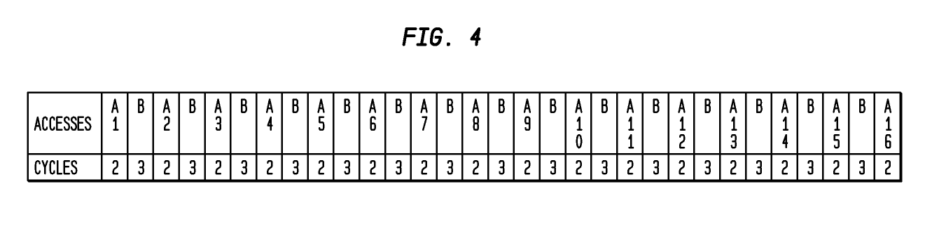

Configuring the data processing system 100 in this manner can have a substantial impact on the number of cycles needed to accomplish memory and I/O device accesses, and may ultimately have a positive effect on the speed of the data processing system 100 as a whole. When transferring 64 bytes of data from the slave device S2 to one of the master devices M0, M1, for example, it is substantially faster to fetch data from the slave device S2 through the second mapped address region than through the first mapped address region. Such an effect is shown conceptually in conjunction with FIGS. 3 and 4.

FIG. 3 shows a table of the modeled number of accesses and system clock cycles (hereinafter “cycles”) that may be required to accomplish such a transfer. Because the access through the second mapped address region is cacheable, portions of the data being transferred may be temporarily stored inside a cache memory, where accesses are faster. Assuming the system interconnect 110 is capable of fetching four bytes per fetch and assuming a cache line with a capacity of 32 bytes (i.e., 8 words), only two accesses are needed to fetch 64 bytes of data. If as indicated in the table, the two accesses (A0 and A1) each consume nine cycles for fetching the data (i.e., eight cycles for fetching data plus one cycle for bus protocol overhead), and three additional cycles are consumed by inter-transaction delay (B), then the total number of cycles needed to make the data transfer is estimated to be about 21 cycles.

Were, in contrast, the second address region and the second set of memory attributes not available, the fetch would have to occur through the first mapped address region and, therefore, in accordance with a “device” memory attribute. FIG. 4 shows a table of the modeled number of accesses and cycles required to accomplish such a transfer under these constraints. Here, again assuming the system interconnect 110 allows the fetching of four bytes per fetch, 16 accesses (AO-A16) would be needed to transfer the 64 bytes of data. If each such access consumes two cycles (one for the fetch plus one cycle for bus protocol overhead) and 45 additional cycles are consumed by inter-transaction delays (B), then the total number of cycles needed to make the data transfer is estimated to be about 77 cycles. Clearly, having the cacheable memory attribute available to the data processors M0, M1 through the second mapped address region in accordance with some embodiments of the invention substantially reduces access times for such a data transfer. At the same time, the “device” memory attribute remains available to the data processors M0, M1 through the first mapped address region for those transactions where that memory attribute may be required.

In order to provide greater ease of use, data processing systems in accordance with some embodiments of the invention are associated with software (i.e., computer readable program code) that aids a computer programmer in accessing different sets of memory attributes for those devices that are mapped to multiple address regions. More particularly, in the present described embodiment, one or more software modules allow a computer programmer to conduct a transaction in accordance with the second set of memory attributes by asserting a base address falling within the first mapped address region and then making a subroutine call. By allowing the computer programmer to provide a base address and then rely on a subroutine call to access the second set of memory attributes, the software modules provide the computer programmer with access to all the memory attributes for S2 while not requiring that the computer programmer possess a detailed understanding of the expanded memory map for the data processing system 100.

The subroutine calls function such as by causing an address offset to be added to the asserted base address, although other means of modifying the base address may be used and the results would still come within the scope of embodiments of the invention. In the above-described embodiment, an address offset of 0x2000_{—}0000 applied to a base address falling within the first mapped address region would provide an address falling within the second mapped address region. Aspects of the subroutines are defined by a series of properties in, for example, an application programming interface (API) for the access library. Non-limiting examples of programming languages that may be used for the software modules include markup languages, C/C++, assembly language, Pascal, Java, and the like.

In accordance with some embodiments of the invention, two address regions assigned to the same device but having different sets of memory attributes may be sub-regions of one larger address region that is mapped to that device. In addition, the memory attributes assigned to the same device through multiple mapped address regions may be mutually exclusive. In the embodiment shown in FIG. 2, for example, the first mapped address region was assigned a “device” memory attribute while the second mapped address region was assigned a “normal” memory attribute. Other iterations might, as just a few more examples, have a single device assigned both “normal” and “strongly ordered” memory attributes or have a single device assigned both “device” and “strongly ordered” memory attributes. In any case, as illustrated above, the assignment of multiple memory attributes to the same device gives a data processing system in accordance with some embodiments of the invention much greater flexibility in choosing what memory attributes to utilize with what transactions. Accessing the different memory attributes may be accomplished by merely choosing from different mapped address regions when addressing a device. Ultimately, system performance benefits.

Some care, nonetheless, must be exhibited when having the same device perform transactions utilizing different sets of memory attributes, particularly when those transactions are proximate in time to one another. When a device is first accessed in accordance with a “normal” memory attribute and is subsequently accessed in accordance with a “strongly ordered” memory attribute, it may, for example, be beneficial to have a data processing system perform a memory barrier instruction between the transactions. A memory barrier instruction may, for example, act to clear a cache memory. Such a memory barrier instruction may, for instance, act to stop any out-of-order transactions and remove transaction dependencies generated under the “normal” memory attribute from adversely affecting program behavior while performing those transactions that must be maintained in strict order under a “strongly ordered” memory attribute.

Once the novel functionality of an embodiment of the invention is understood given the teachings herein, embodiments of the invention such as the data processing system 100 may be implemented in hardware utilizing largely conventional digital electronics design techniques by one having ordinary skill in that art. One skilled in the art would recognize, for example, that the system interconnect 110 may comprise hardware components such as, but not limited to, buses, buffers, arbiters, protocol conversion components, frequency/data converters, controllers, ports, adapters, and the like. An interconnect architecture suitable for the present invention includes, but is not limited to, one in accordance with the Advanced Microcontroller Bus Architecture (AMBA). Relevant aspects of computer architecture design are described in several readily available references.

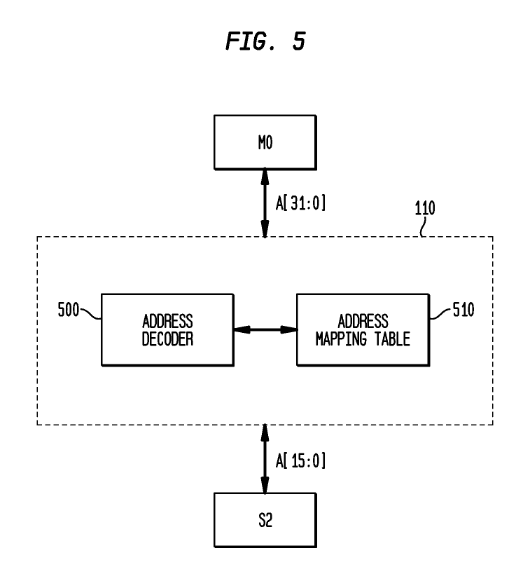

An embodiment of the invention comprises a system interconnect 110 that performs both address decoding and transaction/data routing functions. FIG. 5 shows a simplified block diagram of at least some of the elements within the system interconnect 110 according to an embodiment of the invention and how those elements might be utilized to direct a transaction command from the master device M0 to the slave device S2. In this embodiment, the system interconnect 110 comprises an address decoder 500 and an address mapping table 510. The address mapping table 510 comprises a listing of the mapped address regions for the slave devices S0-S3 in a manner similar to the table in FIG. 2. For exemplary purposes, it is assumed that the master device M0 provides a 32-bit address, A[31:0], although embodiments of the invention are not limited to any specific address size.

When a transaction command with a 32-bit address from the master device M0 arrives at the system interconnect 110, the address decoder 500 looks up that address in the address mapping table 510 and determines that the address belongs to the slave device S2. The address decoder 500 then truncates the address to the size of the largest of the address regions mapped to the slave device S2 (in this case, 16 bits corresponding to a 64 kilobyte (KB) mapped address region). Subsequently, the system interconnect 110 transmits the command with the truncated address, A[15:0], to the slave device S2 via a port belonging to that device. The truncation of the address maintains the base address information for the slave device S2 (i.e., the least significant 16 bits) but removes any information that indicates a particular mapped address region and its corresponding set of memory attributes. The slave device S2 simply responds to the command and base address according to its accompanying access attributes without knowledge of which of two (or more) mapped address regions were actually accessed. In this manner, the slave device S2, and, more particularly, slave devices in general, may be accessed in accordance with embodiments of the invention without requiring that the slave devices be modified to decode addresses larger than their respective memory capacities.

As indicated above, embodiments of the invention can employ hardware or hardware and software aspects. Software includes but is not limited to firmware, resident software, microcode, etc. One or more embodiments of the invention or elements thereof can be implemented in the form of an apparatus including a machine readable medium that contains one or more programs which when executed implement such step(s); that is to say, a computer program product including a tangible computer readable recordable storage medium (or multiple such media) with computer-usable program code configured to implement the method indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

As is known in the art, at least a portion of one or more embodiments of the methods and apparatus discussed herein may be distributed as an article of manufacture that itself includes a computer readable medium having non-transient computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store, in a non-transitory manner, information suitable for use with a computer system may be used. The computer-readable code means is intended to encompass any mechanism for allowing a computer to read instructions and data, such as magnetic variations on a magnetic medium or height variations on the surface of a compact disk. As used herein, a tangible computer-readable recordable storage medium is intended to encompass a recordable medium, examples of which are set forth above, but is not intended to encompass a transmission medium or disembodied signal.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the invention can include a processor including code adapted to cause the processor to carry out one or more steps of methods or claims set forth herein, together with one or more apparatus elements or features as depicted and described herein.

Moreover, at least a portion of the techniques of embodiments of the invention may be implemented in an integrated circuit. In forming integrated circuits, identical die are typically fabricated in a repeated pattern on a surface of a semiconductor wafer. Each die includes an element described herein, and may include other structures and/or circuits. The individual die are cut or diced from the wafer, then packaged as an integrated circuit. One skilled in the art would know how to dice wafers and package die to produce integrated circuits. Any of the exemplary elements illustrated in, for example, FIGS. 1 and 5, or portions thereof, may be part of an integrated circuit. Embodiments of the invention may be or include integrated circuits so manufactured

It should again be emphasized that the above-described embodiments of the invention are intended to be illustrative only. Other embodiments may use different types and arrangements of elements for implementing the described functionality. These numerous alternative embodiments within the scope of the appended claims will be apparent to one skilled in the art given the teachings herein. What is more, the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

What is claimed is:

1. A data processing system comprising:
a device, the device mapped to a first mapped address region and to a second mapped address region; and
device access circuitry, the device access circuitry operative to access the device in accordance with a first set of memory attributes when addressing the device within the first mapped address region and to access the device in accordance with a second set of memory attributes when addressing the device within the second mapped address region;
wherein the first set of memory attributes is different from the second set of memory attributes.

2. The data processing system of claim 1, wherein the data processing system utilizes memory-mapped input/output.

3. The data processing system of claim 1, wherein the device comprises a memory.

4. The data processing system of claim 3, wherein the memory comprises a read-only memory.

5. The data processing system of claim 3, wherein the memory comprises a random access memory.

6. The data processing system of claim 1, wherein the device comprises an input/output device.

7. The data processing system of claim 6, wherein the input/output device comprises at least one of a memory peripheral, a video peripheral, a sound peripheral, a sensor peripheral, a network peripheral, and a data processing peripheral.

8. The data processing system of claim 1, wherein the device access circuitry comprises one or more data processors.

9. The data processing system of claim 1, wherein the first set of memory attributes and the second set of memory attributes include mutually exclusive memory attributes.

10. The data processing system of claim 1, wherein the first set of memory attributes comprises a “normal” memory attribute, and the second set of memory attributes comprises a “device” memory attribute.

11. The data processing system of claim 1, wherein the first set of memory attributes comprises a “normal” memory attribute, and the second set of memory attributes comprises a “strongly ordered” memory attribute.

12. The data processing system of claim 1, wherein the first set of memory attributes comprises a “device” memory attribute, and the second set of memory attributes comprises a “strongly ordered” memory attribute.

13. The data processing system of claim 1, wherein the first set of memory attributes comprises a “cacheable” memory attribute, and the second set of memory attributes comprises a “non-cacheable” memory attribute.

14. The data processing system of claim 1, wherein the data processing system is operative to place a memory barrier instruction between accesses to the first mapped address region and accesses to the second mapped address region.

15. The data processing system of claim 14, wherein the memory barrier instruction comprises a cache processing instruction.

16. The data processing system of claim 1, wherein accessing the device in accordance with the second set of memory attributes allows a given transaction to be performed in less time than would be required if the device were accessed in accordance with the first set of memory attributes.

17. The data processing system of claim 1, further comprising a software module, wherein the data processing system is operative to modify an address falling within the first mapped address region to create a modified address falling within the second mapped address region by executing the software module.

18. The data processing system of claim 17, wherein the software module is embodied on a non-transient computer-readable storage medium.

19. The data processing system of claim 1, wherein the first mapped address region and the second mapped address region are sub-regions of one larger mapped address region for the device.

20. A method for accessing a device in a data processing system, the method comprising the steps of:
mapping the device to a first mapped address region and to a second mapped address region; and
causing device access circuitry to access the device in accordance with a first set of memory attributes when addressing the device within the first mapped address region and to access the device in accordance with a second set of memory attributes when addressing the device within the second mapped address region;
wherein the first set of memory attributes is different from the second set of memory attributes.

21. An integrated circuit comprising:
a device, the device mapped to a first mapped address region and to a second mapped address region; and
device access circuitry, the device access circuitry operative to access the device in accordance with a first set of memory attributes when addressing the device within the first mapped address region and to access the device in accordance with a second set of memory attributes when addressing the device within the second mapped address region;
wherein the first set of memory attributes is different from the second set of memory attributes.
